(19) United States
(12) Patent Application Publication
(10) Pub. No.: US 2015/0329094 A1
(43) Pub. Date: Nov. 19, 2015

(54) HYDRAULIC MODULE FOR AN ANTILOCK BRAKING SYSTEM FOR A TWO-WHEELED VEHICLE

(71) Applicant: ROBERT BOSCH GMBH, Stuttgart (DE)

(72) Inventors: Andreas WEH, Sulzberg (DE); Matthias HURST, Immenstadt (DE)

(21) Appl. No.: 14/760,925

(22) PCT Filed: Nov. 21, 2013
(86) PCT No.: PCT/EP2013/074338

§ 371 Date: Jul. 14, 2015

(30) Foreign Application Priority Data
Jan. 14, 2013 (DE) 10 2013 200 419.2

(51) Int. Cl. B60T 8/36; B60T 8/17; B62L 3/02

(52) U.S. Cl. CPC B60T 8/3675; B62L 3/023; B60T 8/1706

(57) ABSTRACT

A hydraulic module for a hydraulic antilock braking system for a two-wheeled vehicle, the hydraulic module including a first hydraulic connection for connecting the hydraulic module by a hydraulic line to a brake-actuating device; a second hydraulic connection for connecting the hydraulic module by a hydraulic line to a wheel brake; an inlet valve for connecting and disconnecting the first hydraulic connection to/from the second hydraulic connection; an outlet valve for connecting and disconnecting a pressure accumulator to/from the second hydraulic connection; and a housing in which the inlet valve and the outlet valve are accommodated and which provides the first hydraulic connection and the second hydraulic connection.

### FIELD OF THE INVENTION

The present invention relates to a hydraulic module for an antilock braking system for a two-wheeled vehicle, as well as a two-wheeled vehicle having such a hydraulic module.

### BACKGROUND INFORMATION

A bike antilock braking system is able to increase the safety of the biker and the other road users. For example, bike antilock braking systems are known which control the braking force mechanically via control cables.

The growing market of electrically powered bikes (referred to as E-bikes), and the continuous availability of electrical energy on the bike associated with it, offers new possibilities for active biker protection. In addition, in principle, the electric motor support for the biker increases the average speed, and moreover, also makes it possible for less experienced bikers to reach higher located destinations.

In the motorcycle sector, antilock braking systems are known which operate with a return principle, analogous to motor-vehicle antilock braking systems. In that case, the brake fluid is conveyed out of the brake by a pump and a motor back in the direction of the brake lever.

### SUMMARY

An object of the present invention is to provide an antilock braking system for a two-wheeled vehicle that is inexpensive and easy to install.

One aspect of the present invention relates to a hydraulic module or antilock-braking-system control module for a hydraulic antilock braking system for a two-wheeled vehicle, e.g., for an E-bike or a moped.

According to one specific embodiment of the invention, the hydraulic module includes a first hydraulic connection for connecting the hydraulic module by a hydraulic line to a brake actuating device; a second hydraulic connection for connecting the hydraulic module by a hydraulic line to a wheel brake; an inlet valve for connecting and disconnecting the first hydraulic connection to/from the second hydraulic connection; and an outlet valve for connecting and disconnecting a pressure accumulator to/from the second hydraulic connection. The hydraulic module also includes a housing in which the inlet valve and the outlet valve are accommodated, and which provides the first hydraulic connection and the second hydraulic connection.

The hydraulic module includes many or all hydraulic components of the antilock braking system, which are provided in their own housing and thus may be secured in an easy manner to the two-wheeled vehicle. For example, the housing may be a plastic component in which, for instance, the valves are integrally cast, since the housing is normally exposed to only a limited temperature range and a limited pressure range.

The housing may be provided as a simple blank. It may only be necessary to use a small amount of material for the housing. For example, the housing may be an injection-molded part. The housing or the hydraulic module then has a small box volume and a low weight.

With the ready-to-install hydraulic module, no reworking is necessary during installation on the two-wheeled vehicle.

Standard functional elements from automotive engineering may be used for the valves and the pressure accumulator.

Since the hydraulic module is able to have only a few components, a rotary-table production is possible, therefore permitting a cost-effective short sequencing of the production.

According to one specific embodiment of the invention, the hydraulic module further includes the pressure accumulator in the housing. A further opening may be provided in the housing, into which the pressure accumulator may be received. The pressure accumulator is designed to convey brake fluid back into the hydraulic connection between the inlet valve and the wheel brake by reducing its variable volume, for example. To that end, the pressure accumulator may have a spring element that is tensioned upon filling of the pressure accumulator. For instance, the pressure accumulator may be emptied again by pushback of the piston. In general, the pressure accumulator is able to temporarily store the pressure present upon filling and use it to empty itself again autonomously.

It is to be understood that the openings for the valves and/or the pressure accumulator may be bore-like openings that, for example, at least sectionally have a cylindrical internal surface.

According to one specific embodiment of the present invention, the hydraulic module also includes an electronic control in the housing, e.g., on a circuit board having a processor. The control may be designed to drive the inlet valve and the outlet valve and to open and close them as a function of an ascertained locked state of a wheel of the two-wheeled vehicle. The inlet valve may be an electrical inlet valve that closes in response to energizing, for example. The outlet valve may be an electrical outlet valve that, e.g., opens in response to energizing. If the wheel is not locked, both valves may remain unenergized. In the event the wheel is locked, first of all, the inlet valve may be closed and the outlet valve may possibly be opened.

For example, a circuit board of the control may be disposed above the valves inserted into the housing and embedded and/or cemented together with them in the housing. Consequently, coils of the valves may be prevented from moving relative to the printed circuit board.

According to one specific embodiment of the present invention, an electrical plug-in contact is provided by the housing, the connection being designed to receive various electrical contacts or connections for other components of the two-wheeled vehicle.

The plug-in contact may have a connection for a power supply for the hydraulic module. For instance, this may be a storage battery of an electric bike.

In addition, the control may be designed to receive signals from a speed sensor at a wheel via a connection, and from them, to determine a locked state of the wheel of the two-wheeled vehicle.

The control may further be designed to receive, via a connection, signals from a position sensor of the brake-actuating device and/or from a hydraulic pressure sensor in the hydraulic connection. With these signals, it is possible to determine whether a rider of the bike is intending to brake.

The control may also be designed to output signals to a signal light, which indicate whether the control has detected a locked state. For instance, the signal light may be switched off when the wheel is not locked, and flash when the wheel is locked.

All in all, the inlet valve, the outlet valve and the pressure accumulator may be combined to form one common hydraulic module that provides one common housing for these components, and that, for example, has connections for hydraulic and/or electric lines. A control circuit board having an electronic control may also be disposed in the hydraulic module.

According to one specific embodiment, the housing includes an inlet-valve opening for accommodating the inlet valve and an outlet-valve opening for accommodating the outlet valve, which are positioned parallel to one another. The two valves may be disposed and embedded in these openings (which also may be connected laterally to one another). In particular, interface bores, with which the outlet valve and the inlet valve are connected to a connecting bore, may lie in one plane.

According to one specific embodiment, the housing includes a connecting bore that runs orthogonally to an axis of the inlet valve and/or of the outlet valve, and which leads into the first hydraulic connection. A connecting hole or connecting bore, which goes out from the first hydraulic connection, runs orthogonally to the inlet valve and to the outlet valve. The axis of the connecting bore is perpendicular to the axes of symmetry of the valves.

The printed circuit board for the electronic control may be mounted above the valves, that is, opposite the connecting bore. In addition, a cover of the housing having the connector plug may be mounted above the valves and/or the printed circuit board. In terms of its plane of symmetry, the connector plug (e.g., a cylindrical-type connector) may be mounted parallel to the axes of symmetry of the valves.

According to one specific embodiment, the housing includes a connecting bore which, starting from an inlet-valve opening, bends at a right angle and leads into the second hydraulic connection. An interconnection from the inlet valve to the wheel brake is perpendicular to the axis of symmetry of the inlet valve.

According to one specific embodiment, the housing includes a pressure-accumulator opening for accommodating a pressure accumulator, the opening running parallel to an axis of the inlet valve and/or of the outlet valve. In this manner, a simple assembly of the hydraulic module is possible with only two mounting directions.

The opening for the pressure accumulator (an accumulator interface bore) may be placed opposite a valve opening. An interconnection from the pressure accumulator to the outlet valve may be provided centrally relative to the axis of symmetry of the outlet valve, beginning in the outlet valve and leading into the opening for the pressure accumulator.

According to one specific embodiment, the hydraulic module also includes a holder for receiving the housing, the holder being designed to secure the hydraulic module on a frame element of the two-wheeled vehicle. Consequently, the hydraulic module (possibly standardized for a multiplicity of two-wheeler types) may be fastened to various types of two-wheeled vehicles using various holders.

For example, the holder may include a clip which is designed to at least partially encompass the frame element. The clip may be fixed in position on the frame element by further elements such as screws, for instance.

A further aspect of the present invention relates to a two-wheeled vehicle having a hydraulic module as described above and below. In addition to electrically powered two-wheeled vehicles, the hydraulic module may also be used for motorized two-wheeled vehicles having a combustion motor, especially for low-motorized two-wheeled vehicles, for example, up to a maximum speed of 40 km/h (such as motorized bicycles or mopeds, for instance).

### BRIEF DESCRIPTION OF THE DRAWINGS

FIG. 1 shows a schematic diagram of an antilock braking system according to one specific embodiment of the present invention.

FIG. 2 shows a schematic diagram for a control of an antilock braking system according to one specific embodiment of the present invention.

FIG. 3 shows a schematic diagram for a control of an antilock braking system according to a further specific embodiment of the present invention.

FIG. 4 shows a three-dimensional view of a housing for a hydraulic module according to one specific embodiment of the present invention.

FIG. 5 shows a three-dimensional view of openings in the housing from FIG. 4.

FIG. 6 shows a three-dimensional cross-sectional view of a hydraulic module according to one specific embodiment of the invention.

FIG. 7 shows another three-dimensional view of the hydraulic module from FIG. 6.

FIG. 8 shows a further three-dimensional view of the hydraulic module from FIG. 6.

FIG. 9 shows a sectional view through a hydraulic module prior to being fastened to the two-wheeled vehicle according to one specific embodiment of the invention.

FIG. 10 shows a sectional view through the hydraulic module from FIG. 9 after being fastened to the two-wheeled vehicle.

As a general principle, identical or similar parts are provided with the same reference numerals.

### DETAILED DESCRIPTION

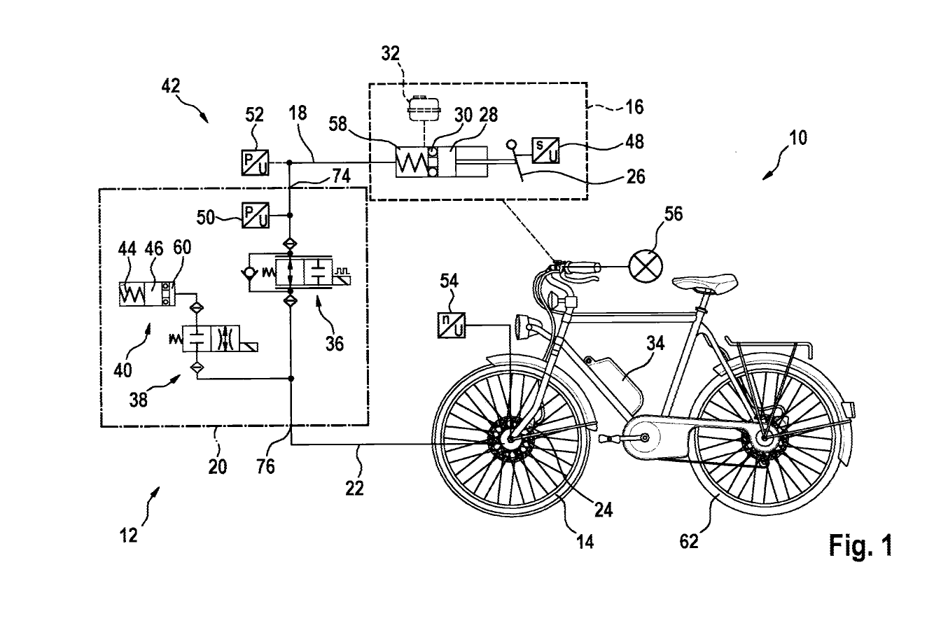

FIG. 1 shows a two-wheeled vehicle 10 having a hydraulic antilock braking system 12, which is designed to reduce locking of front wheel 14 of the two-wheeled vehicle.

The hydraulic components of antilock braking system 12 include a brake-actuating device 16, which is connected via a first hydraulic line 18 to a hydraulic module 20, that is connected by a second hydraulic line 22 to a wheel brake 24. Wheel brake 24 includes a wheel-brake cylinder which, by way of the hydraulic pressure, presses brake pads of the wheel brake against a brake disk or against a wheel rim.

Brake-actuating device 16 includes a brake lever 26, a piston 28 having seal 30, and optionally, a reservoir 32 for brake fluid.

Hydraulic module 20, which together with electrical components may be mounted in a housing 34 on two-wheeled vehicle 10, includes an inlet valve 36, an outlet valve 38 and a pressure accumulator 40.

Inlet valve 36 is mounted between first line 18 and second line 22, and connects or disconnects hydraulic connection 42, that is formed of the two lines 18 and 22 between brake-actuating device 16 and wheel brake 24. Inlet valve 36 may include a non-return valve, be open in the currentless state, be filtered on both sides and/or be traversed by flow on both sides.

Outlet valve 38 is connected hydraulically to second line 22 and to pressure accumulator 40, thus, is connected with hydraulic connection 42 between inlet valve 36 and wheel brake 24. Outlet valve 38 may be closed in the currentless state, be filtered on both sides and/or be traversed by flow on both sides.

Pressure accumulator 40 or temporary storage 40 for brake fluid includes a spring element 44, e.g., a return spring 44, that tensions a piston 46 against the pressure of the brake fluid in line 22.

Brake-actuating device 16 may have a displacement sensor 48 or position sensor 48, with which it is possible to ascertain the instantaneous position of lever 26. A pressure in first hydraulic line 18 and/or of hydraulic connection 42 may be deduced from the position of lever 26. Alternatively or additionally, an internal hydraulic pressure sensor 50 or an external hydraulic pressure sensor 52 may also be used to determine the pressure in first hydraulic line 18 and/or of hydraulic connection 42, and from that, optionally, to infer the position of lever 26.

Internal hydraulic pressure sensor 50 may be a component part of hydraulic module 20. External hydraulic pressure sensor 52 may be disposed outside of hydraulic module 20.

Mounted on wheel 14 of two-wheeled vehicle 10 is a speed sensor 54, with which the instantaneous rotational speed or wheel circumferential velocity of wheel 14 may be ascertained. Speed sensor 54 may include a toothed disk, which may be designed together with the brake disk, but which as an alternative, may also be provided as a separate part.

Besides brake-actuating device 16, a signal light 56 may be mounted on the handlebar of two-wheeled vehicle 10 which, as explained again below, indicates to the rider of two-wheeled vehicle 10 when a control of hydraulic module 20 detects locking of wheel 14.

When the rider of two-wheeled vehicle 10 actuates lever 26, a volume 58 (in a cylinder) is reduced by piston 28, so that brake fluid flows into first line 18 and (if inlet valve 36 is open) gets from there into second line 22 and into wheel brake 24. When wheel brake 24 brakes wheel 14, the pressure in the lines increases. As explained further below, in response to locking of wheel 14, inlet valve 36 may then be closed and outlet valve 38 may be opened. The brake fluid under pressure is then able to get from second line 22 into pressure accumulator 40. As a result, a volume 60 (in a cylinder) is increased, because the brake fluid shifts piston 46 against the force of spring element 44. In this way, the pressure on wheel brake 24 may be reduced, even though the rider is actuating lever 26.

It is possible for two-wheeled vehicle 10 to have a further brake circuit for rear wheel 62, which is identical to the brake circuit shown in FIG. 1. The two brake circuits may be realized with independent hydraulic modules 20 or with one common hydraulic module (in one common housing 34) for front wheel 14 and/or rear wheel 62.

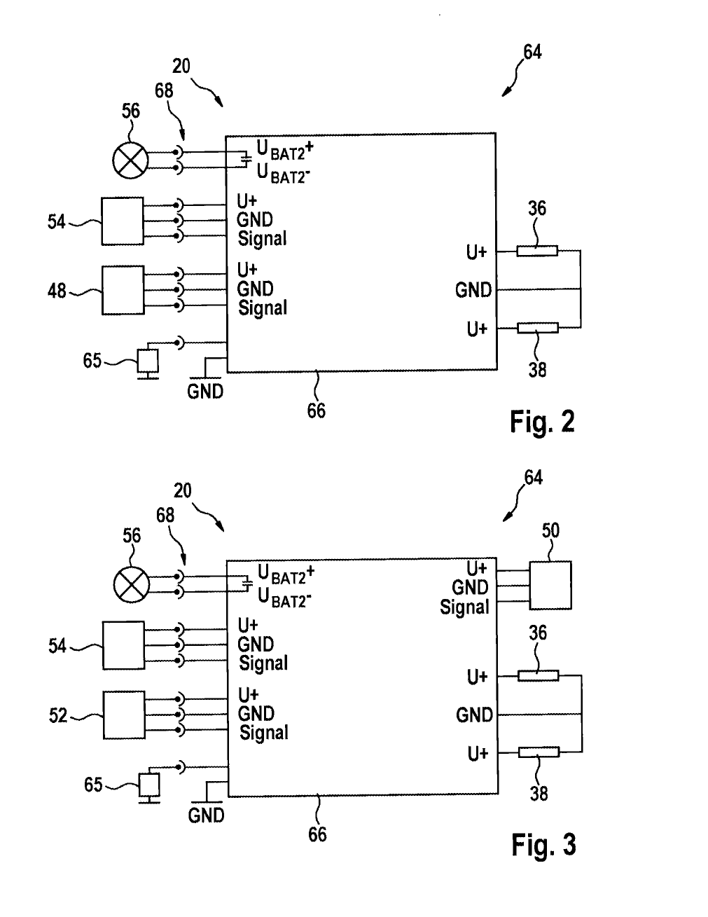

FIG. 2 shows further electrical control components of hydraulic antilock braking system 12. As illustrated in FIG. 2, hydraulic module 20 may include an electronic control 64, which may have a logic circuit on a printed circuit board 66, e.g., having a processor.

Hydraulic module 20 may have connecting terminals 68 for signal light 56, speed sensor 54, position sensor 48 and a power supply 65 (for instance, such as a battery of the two-wheeled vehicle). An independent power supply may be made available for hydraulic module 20 via an additional (internal) button cell battery.

Connecting terminals 68 for hydraulic module 20 include supply pins and signal pins (connectors with external contacts) for ground (GND) for position sensor 48, voltage supply (U+) for position sensor 48 and for the signal of position sensor 48, as well as ground (U_{BAT2-}) for signal light 56 and voltage supply (U_{BAT2+}) for signal light 56. An electric connection or line from brake-actuating device 16 to hydraulic module 20 may be connected to these connecting terminals 68.

In addition, connecting terminals 68 for hydraulic module 20 include supply pins and signal pins (connectors with external contacts) for ground (GND) for speed sensor 54, voltage supply (U+) for speed sensor 54 and for the signal of speed sensor 54. An electric connection or line from speed sensor 54 at wheel 14 to hydraulic module 20 may be connected to these connecting terminals 68.

The hydraulic module further includes a connecting terminal 68 for ground (GND) of hydraulic module 20 and for power supply 65.

Moreover, printed circuit board 66 is connected via internal lines in hydraulic module 20 to inlet valve 36 and outlet valve 38.

FIG. 3 shows an alternative specific embodiment for an electronic control 64, in which hydraulic module 20 has an internal pressure sensor 50. Alternatively or additionally, control 64 may have a connecting terminal 68 for an external pressure sensor 52.

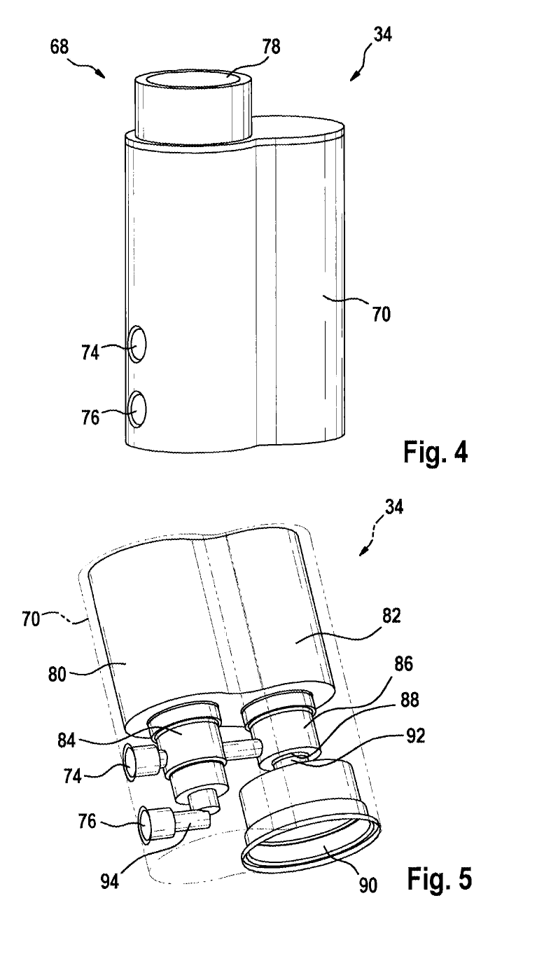

FIG. 4 shows a three-dimensional view of a further specific embodiment of a housing 34 for hydraulic module 20. Housing 34 includes a base 70 having an essentially double-cylinder-shaped cross-section and a cover 72 that is placed on base 70. Base 70 and cover 72 may in each case be produced in one piece, e.g., from plastic or from an aluminum alloy. Housing 34, that is, base 70 and cover 72, may be a plastic housing.

Housing 34, i.e., base 70, has a first hydraulic connection 74 for the connection of brake-actuating device 16. Line 18 may be connected to hydraulic connection 74 with the aid of a hydraulic connector. Housing 34, i.e., base 70, also has a second hydraulic connection 76 for the connection of wheel brake 24. Line 22 may be connected to hydraulic connection 76 with the aid of a hydraulic connector. The two hydraulic connections are placed laterally on housing 34 and run essentially orthogonally to a longitudinal direction of housing 34.

Housing 34, i.e., cover 72 has an electrical plug-in contact 78 which provides connecting terminals 68 or at least a portion of connecting terminals 68. The electrical plug-in contact may protrude beyond cover 72 and run essentially parallel to the longitudinal direction of housing 34.

FIG. 5 shows a three-dimensional view of openings and cutouts in housing 34, that is, in base 70. Two cylindrical openings 80, 82 that overlap laterally provide a coil space and printed-circuit-board space, in which inlet valve 36, outlet valve 38 and printed circuit board 66 may be disposed. The two openings run essentially in parallel and in the direction of the longitudinal axis of housing 34.

Located at the bottom of openings 80, 82 are cylindrical cutouts 84, 86 which have a smaller diameter than openings 80, 82 and no longer overlap each other. Cutout 84 provides an interface 84 for inlet valve 36, and cutout 86 provides an interface 86 for outlet valve 38.

A connecting bore 88 runs transversely to openings 80, 82 or through cutouts 84, 86, so that they are connected by connecting bore 88. Cutout 84 is also connected to first hydraulic connection 74, which runs at the same level with connecting bore 88. Connecting bore 88 provides an interconnection from brake-actuating device 16 to inlet valve 36 and to outlet valve 38. The bore axis of connecting bore 88 may run orthogonally to the axes of symmetry of the two valves 36, 38.

A further opening 90, which lies opposite openings 80, 82 on base 70, is used to accommodate pressure accumulator 40. Opening 90 lies opposite opening 82 for outlet valve 38 and is connected to cutout 86 via a further interconnection 92 which connects pressure accumulator 40 to outlet valve 38. Opening 90 and/or interconnection 92 may run centrally relative to the axis of symmetry of outlet valve 38.

Another connecting bore 94 connects second hydraulic connection 76 to cutout 84. Connecting bore 94 is bent at a right angle and provides an interconnection from inlet valve 36 to wheel brake 24.

Connecting bores 88 and 94 have a somewhat smaller diameter than hydraulic connections 74, 76.

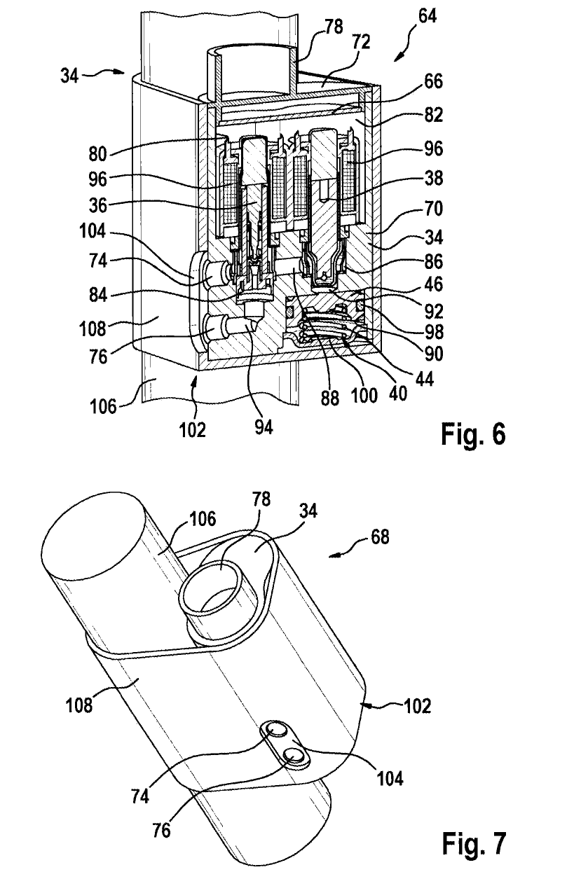

FIG. 6 shows a three-dimensional cross-sectional view of a hydraulic module 20. The hydraulic module was produced by placing both valves 36, 38 in openings 80, 82 of base 70 and casting them in. In addition, the printed circuit board was mounted on valves 36, 38. It is possible for printed circuit board 66 to be cast together with valves 36, 38 into base 70. In that case, coils 96 of valves 36, 38 are located in openings 80, 82, and the respective valve heads are situated in respective cutouts 84, 86. Outlet valve 38, inlet valve 36 and connecting bore 88 are in one plane, connecting bore 88 running transverse to the axis of valves 36, 38. Valves 36, 38 and their coils 96 may be standard components from automotive engineering.

Cover 72 was mounted on the printed circuit board. Alternatively, closing cover 72 may form a collet and be realized as a preassembly. Printed circuit board 66 is situated above coils 96, and cover 72 or connector 78 is situated above coils 96. In terms of its plane of symmetry, connector 78 (e.g., a cylindrical-type connector) is parallel to the axes of symmetry of valves 36, 38.

Pressure accumulator 40, which includes a piston 46, an O-ring 98, a spring 44 and a closing cover 100 that may also be standard components from automotive engineering, was inserted into the accommodation or opening 90.

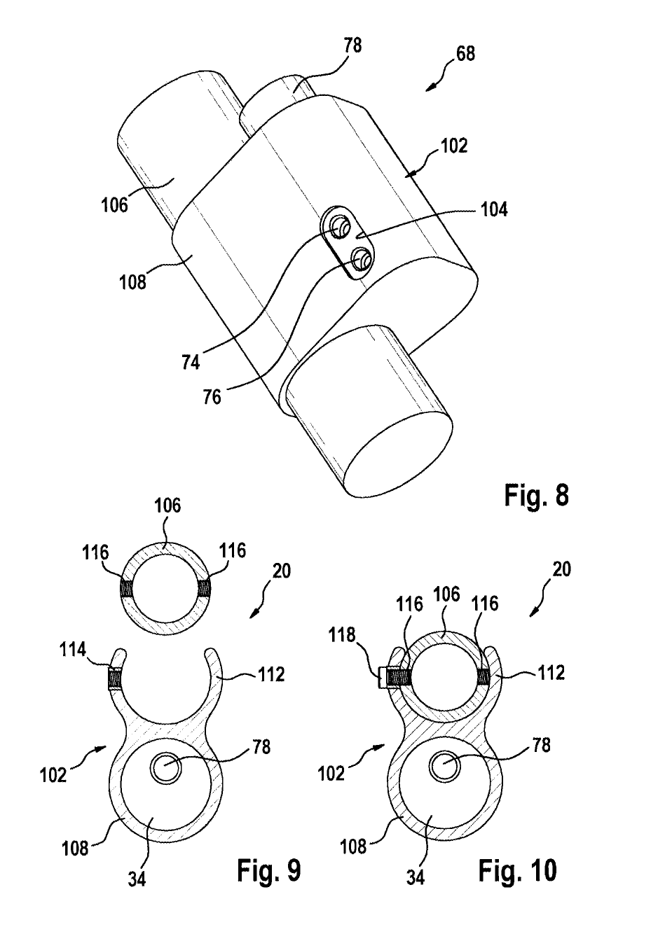

As also shown in FIGS. 7 and 8, the hydraulic module further includes a fixture 102 or a holder 102 that provides an accommodation for housing 34. Located on the side of holder 102 is an opening 104, through which it is possible to access hydraulic connections 74, 76.

Housing 34 is attached to a frame tube 106 of two-wheeled vehicle 10 via holder 102. For example, housing 34 is cemented in holder 102.

The holder has a side wall 108 that at least partially encircles housing 34, and a bottom wall 110, on which housing 34 rests (on the side of pressure accumulator 40). On the other side, plug-in contact 78 projects beyond holder 102.

Housing 34 and the components installed with it may be designed as standard components. In particular, housing 34 may then be produced with high piece numbers, in order to ensure suitable economic efficiency. Holder 102 may be used to produce individual forms with which housing 34 may be placed in the frame area. To that end, pre-assembled standard housing 34 may be fitted into a corresponding negative or receiver of holder 102.

Located on holder 102 are individual customer interfaces which may be designed in accordance with the respective customer requirement or may likewise conform to a standard provided. The frame area of holder 102 may be adapted individually to specific two-wheeled vehicle 10.

FIG. 9 shows a sectional view through a hydraulic module 20 prior to being attached to two-wheeled vehicle 10. FIG. 10 shows hydraulic module 20 after being attached.

Holder 102 from FIGS. 9 and 10 encircles housing 34 with its side wall 108 annularly from all sides.

Holder 102 has a clamp, pressure clip or clip 112, with which hydraulic module 20 may be secured to frame tube 106. The clip may be fixed in position on frame tube 106 with the aid of a connecting element.

A bushing 114 (e.g., made of metal) may be located in clip 112, with which clip 112 may be secured via a thread 116 in frame tube 106 with the aid of a screw 118.

Additionally, it should be pointed out that “including” does not exclude other elements or steps, and “a” or “one” does not exclude a plurality. It should further be noted that features or steps which have been described with reference to one of the exemplary embodiments above may also be used in combination with other features or steps of other exemplary embodiments described above.

1.-10. (canceled)

11. A hydraulic module for a hydraulic antilock braking system for a two-wheeled vehicle, comprising:
a first hydraulic connection for connecting by a first hydraulic line to a brake-actuating device;
a second hydraulic connection for connecting by a second hydraulic line to a wheel brake;
an inlet valve for connecting and disconnecting the first hydraulic connection one of to and from the second hydraulic connection;
an outlet valve for connecting and disconnecting a pressure accumulator one of to and from the second hydraulic connection; and
a housing in which the inlet valve and the outlet valve are accommodated, and that provides the first hydraulic connection and the second hydraulic connection.

12. The hydraulic module as recited in claim 11, wherein the pressure accumulator is located in the housing.

13. The hydraulic module as recited in claim 11, further comprising an electronic control in the housing.

14. The hydraulic module as recited in claim 11, wherein:
the housing includes an electrical plug-in contact that includes connecting terminals implemented for at least one of the following: a power supply for the hydraulic module; a speed sensor on a wheel of the two-wheeled vehicle; a position sensor for a lever on the brake-actuating device; a pressure sensor; and a signal light.

15. The hydraulic module as recited in claim 11, wherein:
the housing includes an inlet valve opening for accommodating the inlet valve and an outlet valve opening for accommodating the outlet valve, the inlet valve opening and the outlet valve opening being positioned parallel to one another.

16. The hydraulic module as recited in claim 11, wherein the housing includes a connecting bore that runs orthogonally to an axis of at least one of the inlet valve and the outlet valve, and that leads into the first hydraulic connection.

17. The hydraulic module as recited in claim 11, wherein the housing includes a connecting bore that, starting from an inlet valve opening, bends at a right angle and leads into the second hydraulic connection.

18. The hydraulic module as recited in claim 11, wherein the housing includes a pressure-accumulator opening for accommodating the pressure accumulator, the pressure-accumulator opening running parallel to an axis of at least one of the inlet valve and the outlet valve.

19. The hydraulic module as recited in claim 11, further comprising:
a holder for accommodating the housing, wherein the holder secures the hydraulic module to a frame element of the two-wheeled vehicle.

20. A two-wheeled vehicle, comprising:
a hydraulic module for a hydraulic antilock braking system for the two-wheeled vehicle, the hydraulic module including:
a first hydraulic connection for connecting by a first hydraulic line to a brake-actuating device;
a second hydraulic connection for connecting by a second hydraulic line to a wheel brake;
an inlet valve for connecting and disconnecting the first hydraulic connection one of to and from the second hydraulic connection;
an outlet valve for connecting and disconnecting a pressure accumulator one of to and from the second hydraulic connection; and
a housing in which the inlet valve and the outlet valve are accommodated, and that provides the first hydraulic connection and the second hydraulic connection.
